(19) United States
(12) Patent Application Publication
(10) Pub. No.: US 2025/0216678 A1
(43) Pub. Date: Jul. 3, 2025

(54) Holographic Direct View Display for a Vehicle

(71) Applicant: Bayerische Motoren Werke Aktiengesellschaft, Muenchen (DE)

(72) Inventors: Michael Arthur JANZER, Unterschleissheim (DE); Lutz LORENZ, Deisenhofen (DE)

(21) Appl. No.: 18/850,118

(22) PCT Filed: Feb. 28, 2023
(86) PCT No.: PCT/EP2023/054927

§ 371 Date: Sep. 24, 2024

(30) Foreign Application Priority Data
May 25, 2022 (DE) 10 2022 113 344.3

(51) Int. Cl. G02B 27/01; G02B 27/00

(52) U.S. Cl. CPC G02B 27/0103; G02B 27/0093; G02B 27/0149; G02B 2027/0109; G02B 2027/013; G02B 2027/0138; G02B 2027/014; G02B 2027/0154

(57) ABSTRACT

A holographic direct view display for a vehicle includes a display light source for generating at least partly coherent display light and a two-dimensional micromirror array arranged opposite thereto in the field of view of a user. Each micromirror is configured as an electrically controllable display pixel by virtue of being translationally displaceable in a direction transverse to the mirror surface, in order to impress a phase shift on the display light reflected thereon, for the purpose of the holographic reconstruction of a desired display image, and is additionally rotatable about at least its first axis of rotation, in order to alternately reflect the display light generated by the display light source to a respective eye of the user. The display light source is arranged outside of a user display viewing angle, which occupies a spatial region between an eye box predetermined for the user's eyes and the micromirror array.

### BACKGROUND AND SUMMARY

The invention relates to a holographic direct view display which is usable in particular in a vehicle such as a motor vehicle or any other land craft, aircraft or watercraft. The invention is also directed to an associated operating method, an appropriately configured control unit, and a vehicle equipped therewith.

The use of energy-efficient displays is becoming ever more important as vehicles become increasingly electrified. Moreover, the demand for innovative concepts providing experiences is becoming ever greater as the digitization of our world progresses. Among these priorities, there is strong interest in highly efficient holographic displays in which spatial phase modulation by way of electrically controllable pixels is used for holographic reconstruction of a desired display image. In particular, three-dimensional display images can also be created in addition to two-dimensional ones, without the use of additional techniques such as autostereoscopy or 3-D glasses.

However, a practical realization of a holographic direct view display (also referred to as “holo display” in the prior art) is associated with numerous technical difficulties. For example, for pixel dimensions that are realizable from a technical point of view, both currently and in the foreseeable future, a best case observation angle of only a few degrees is so small that the light source would have to be practically directly in front of the eyes of a user in the case of a holo display based on reflection. This represents a major disadvantage, especially for use in a vehicle. Transmissive displays include, inter alia, high intensity losses among the known disadvantages.

The problem addressed by the present invention is that of specifying alternative and/or improved display technology, which is suitable in particular for use in a vehicle and enables improvement over known display concepts, for example in view of the energy efficiency, ergonomics, the representability of 3-D content, the contrast, the visibility, the image quality and/or other aspects.

This problem is solved by a holographic direct view display and by an associated operating method, an appropriately configured control unit and a vehicle equipped therewith according to the claimed invention. All additional features and effects specified in the claims and the following description for the holographic direct view display also apply in relation to the operating method, the control unit and the vehicle, and vice versa.

A first aspect provides a holographic direct view display (also referred to as “holo display” herein for short) which may be designed in particular for use in a vehicle. For example, the vehicle can be a motor vehicle, but also any other land craft, aircraft or watercraft.

The holo display presented herein comprises a display light source embodied to create at least partly coherent display light and a two-dimensional micromirror array arranged opposite therefrom, from where the display light is reflected directly to the eyes of a user (for example a driver or any other occupant of the vehicle). In this case, each micromirror is embodied as a display pixel that is electrically controllable independently of the other micromirrors by virtue of being translationally displaceable in a direction transverse to its mirror surface in order to impress a respective required phase shift for holographic reconstruction of a desired (two- or three-dimensional) display image on the display light reflected thereon. Moreover, each micromirror is rotatable at least about a first axis of rotation (and optionally additionally about a crossed second axis of rotation) in order to reflect the display light to a respective current eye position of the user, wherein the entire display light beam is in each case provided for a respective eye of the user in alternation by the micromirror array during the operation of the holo display.

In order to not impede the forward view of the user, i.e. on the holo display and in particular through the windshield of the vehicle as well, and also to not restrict the user in their freedom of movement, the display light source in this case is arranged outside of a user display viewing angle that fills out a spatial region between a predetermined eyebox of the holo display for the user's eyes and the micromirror array. As is conventional, an eyebox refers to a two-dimensional or three-dimensional spatial region determined for the eyes of the user and from where the display image is visible without restrictions for the user.

One idea of the presently presented holo display thus consists in the micromirror array thereof being embodied and used not only for the image creation but also for the deflection of the display light from the display light source such that said display light is incident on the eyes of the observer (i.e. user) even if the light source is positioned not directly in front of their pupil but outside of their viewing angle (for example to the side of or above their head). Disadvantages of the prior art mentioned at the outset can thus be overcome by way of the image-creating translational displacement of the individual micromirrors in combination with the rotation thereof for deflecting light to the respective eye position, for example on the basis of a suitable eye-tracking signal.

The structure presented herein of the holographic direct view display makes it possible to render the entire light intensity created by the display light source visible to the user as a display image, virtually without losses, since light deflection by way of angles of rotation of individual micromirrors is extremely efficient. At the same time, the structure has absolutely no impact on user comfort, is ergonomic and allows the creation of three-dimensional display images (i.e. three-dimensional display objects) without additional technologies such as 3-D glasses or autostereoscopy etc., and so the proposed holo display is highly suitable in this regard too for use in a vehicle.

The direction of the translational displacement of a micromirror, transverse to the mirror surface, can be constant over time and/or the same for all micromirrors of the micromirror array in a simple case. However, it may also vary from micromirror to micromirror, for example in each case in a manner dependent on its rotational position, for example by virtue of it corresponding to the direction of its respective surface normal.

For example, the display light source can be embodied as one (or more) laser light source(s) for creating display light at one (or more) predetermined wavelength(s).

In particular, any desired phase offset of between 0 and 2π radians can be creatable between the individual pixels/micromirrors by way of the aforementioned translational displacement. Depending on the rotational position of each individual micromirror and depending on how the transverse direction of its displacement is defined relative thereto, the displacement direction of the micromirror can generally deviate from the light propagation direction of the display light reflected therefrom. In this case, the component of the displacement contributing to the phase shift is obtained by an orthogonal projection on the associated light propagation direction in accordance with the angle of incidence and angle of reflection of the reflected display light.

In particular, each individual micromirror can be translationally displaceable within a displacement interval which, in orthogonal projection on the associated light propagation direction of the display light reflected thereon, corresponds to half a predetermined wavelength (or optionally half of the largest of a plurality of predetermined wavelengths) of the display light. This allows the displaceability of the micromirrors to be restricted to a minimum required to create any desired phase offset between the individual pixels.

Further, the holo display can comprise in particular an eye-tracking device embodied to ascertain a current position of each eye of the user. For example, it may comprise one or more cameras to this end, which can be integrated or able to be assembled in or on the micromirror array or to the side thereof. In this case, each micromirror is controllable for the rotation at least about its first axis of rotation, in such a way that the display light created by the display light source is reflected by the micromirror array to the respective currently ascertained position of the relevant eye of the user. An eye-tracking device for the user usable to this end can alternatively also be provided independently of the holo display, i.e. in any case, for example like onboard a vehicle as a constituent part of a driver-monitoring system, etc.

In particular, each micromirror of the micromirror array can be embodied to optically image the display light source into the respective eye of the user. To this end, it can be embodied as a suitable concave mirror or else as a so-called Fresnel mirror with the optical function of a concave mirror. In a manner similar to the functional principle of a Fresnel lens, a Fresnel mirror can obtain largely the same functionality as a conventional concave mirror while having a substantially flatter construction.

As mentioned, the aforementioned rotatability of each micromirror of the micromirror array may comprise rotatability about two crossed (i.e. intersecting, for example perpendicularly arranged) axes of rotation: the aforementioned first axis of rotation and additionally, crossed therewith, a second axis of rotation of the respective micromirror. By rotating the micromirrors about two independent axes of rotation in each case, the micromirror array can be precisely adapted to corresponding multidimensional movements of the user's eyes.

According to an embodiment, the holo display also comprises a calibration device embodied and configured to monitor, and where required correct or calibrate, the functionality of the micromirror array with regard to proper reflection/imaging of the display light source to the respective eye of the user. To this end, the calibration device comprises an infrared light source arranged next to or integrated in the display light source such that it emits an infrared light beam substantially of the same shape and in the same direction as the display light beam created by the display light source. The calibration device further comprises a calibration computing unit embodied and configured to receive, for example from a suitable infrared camera, infrared recordings of a spatial region with the predetermined eyebox for the user's eyes, detect therein an image of the infrared light beam on a face of the user, determine deviations from a predetermined imaging quality and, in the case of determined deviations, control the micromirrors to perform such a rotation and/or translational displacement that these deviations are reduced and ideally eliminated.

A further aspect provides a method for operating a holographic direct view display as presented herein. The method comprises the creation of the at least partly coherent display light by the display light source and the control of the micromirrors of the micromirror array to perform such a rotation about their first and/or optionally second axis of rotation that the display light created by the display light source is reflected to a respective eye of the user in alternation by the micromirror array. In the process, each micromirror is controlled to perform such a translational displacement in a direction transverse to its mirror surface that a phase shift required for the holographic reconstruction of a current two- or three-dimensional display image is impressed on the display light reflected therefrom. For example, the translational displacement of all micromirrors can be performed at predetermined time intervals for the purpose of creating a respective new display interval, with these time intervals not being resolvable by the human eye, wherein all micromirrors can be rotated therebetween for the purpose of changing the light steering direction to the respective other eye of the user.

In a specific configuration of the method, in addition to the rotation of each micromirror its translational displacement in the aforementioned transverse direction can additionally also be used to steer the display light created by the display light source from the micromirror array to the respective eye of the user. To this end, an additional phase shift contributing to the required light deflection to the respective eye of the user can be impressed on the display light reflected by said micromirror array, in addition to the aforementioned phase shift required for the holographic reconstruction of the respective display image. For example, this can be used for fine setting or readjustment of the light steering function of the micromirror array, especially during the calibration as described above and below.

According to an embodiment, a calibration of the reflection of the display light, created by the display light source, to the respective eye of the user brought about by the micromirror array is also carried out. To this end, use can be made in particular of the calibration device as specified above and in the claims. The calibration comprises the following steps:
creating an infrared light beam substantially of the same shape and in the same direction as the display light beam;
providing infrared recordings of a spatial region with the predetermined eyebox for the user's eyes;
detecting an image of the infrared light beam on a face of the user within these infrared recordings and checking said image for deviations (for example defocusing) from a predetermined imaging quality; and
controlling the micromirrors to perform such a rotation and/or translational displacement that the determined deviations are reduced and ideally eliminated if deviations from the predetermined imaging quality are determined.

A control unit embodied and configured to automatically perform the operating method, as presented herein, for the holo display is provided according to a further aspect. To this end, an appropriate computer program, for example, can be executed in the control unit.

A vehicle, in particular a motor vehicle or any other land craft, aircraft or watercraft, is provided according to a further aspect. Terms relating to spatial orientation, such as “top”, “bottom”, “on”, “under”, “laterally”, “front”, “horizontal”, “vertical”, etc., as used herein, relate to the usual vehicle-fixed Cartesian coordinate system containing mutually perpendicular longitudinal, transverse and height axes of the vehicle.

The vehicle comprises a passenger compartment upwardly delimited by a roof liner at least in part; a vehicle seat arranged in the passenger compartment and having a headrest; and a holographic direct view display of the type presented herein, designed for use by a user on the aforementioned vehicle seat. In particular, the aforementioned control unit may also be provided in the vehicle. In this case, the display light source is arranged outside of a user display viewing angle that fills out a spatial region between a predetermined eyebox for the user's eyes in the passenger compartment and the micromirror array. In particular, to this end, the display light source can be arranged on or in the roof liner or at, in or on the headrest of the vehicle seat.

The aforementioned aspects of the invention and their embodiments and specific configurations are explained in more detail below on the basis of examples depicted in the attached drawings. The drawings are highly simplified schematic illustrations of the basic optical construction principle, i.e. should in particular not be construed as true to scale.

### BRIEF DESCRIPTION OF THE DRAWINGS

FIG. 1 shows a lateral longitudinal section through a holo display of the type presented herein in a motor vehicle, wherein the display light source is arranged in the region of a roof liner or a headrest for a user.

FIG. 2a shows a plan view of a holo display of the type presented herein in an operating position of its micromirror array in which the display light is reflected to a right eye of the user.

FIG. 2b shows a plan view of the holo display from FIG. 2a in a further operating position obtained by the rotation of its micromirrors, in which the display light is reflected to a left eye of the user.

FIG. 2c shows a plan view of the holo display from FIG. 2b with displacement intervals of individual micromirrors in directions transverse to the mirror surfaces thereof, for the purpose of creating phase patterns for the holographic display image creation.

FIGS. 3a-3c show phase diagrams for explaining an embodiment of the operating method of a holo display of the type presented herein, with a superposition (FIG. 3c) of two phase patterns, of which the first (FIG. 3a) serves for holographic image creation and the second (FIG. 3b) for supplementary fine adjustment for the light steering in addition to the rotation of individual micromirrors.

### DETAILED DESCRIPTION OF THE DRAWINGS

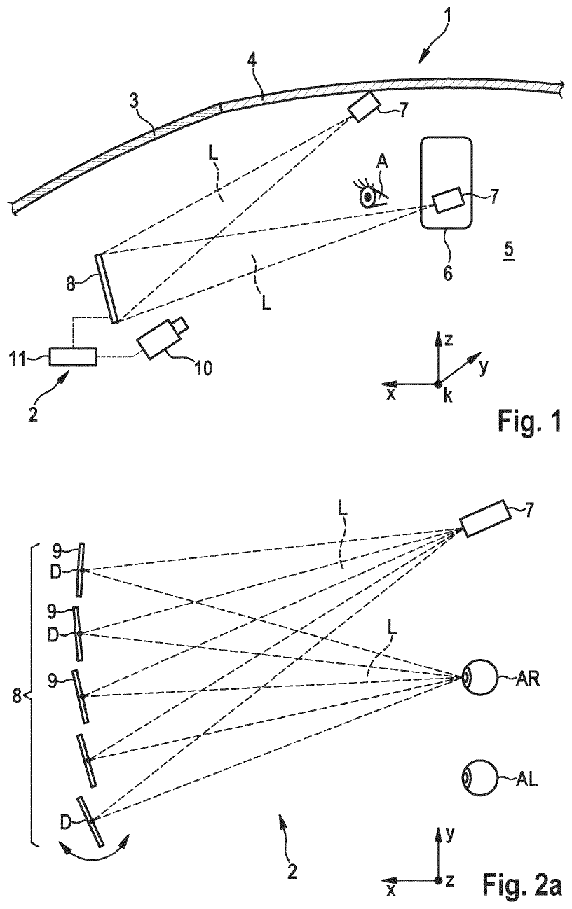

All of the various embodiments, variants and specific design features of the holographic direct view display, its operating method, the control unit and the vehicle according to the aforementioned aspects of the invention, as mentioned above in the description and in the appended claims, may be implemented in the examples shown in FIGS. 1 to 3c. Thus, they are not all repeated again in the following text. The same applies accordingly to the term definitions and effects, already specified above, in relation to individual features shown in FIGS. 1-3c.

FIG. 1 shows a highly simplified lateral longitudinal sectional illustration of an exemplary embodiment of a vehicle 1 having, integrated therein, a holographic direct view display 2 (holo display for short) according to the aforementioned aspects of the invention. In this example, the vehicle 1 is a motor vehicle indicated in FIG. 1 only by way of its windshield 3 and a roof liner 4, which delimit a passenger compartment 5 to the front and to the top. As already mentioned, all terms relating to spatial orientation, such as “top”, “bottom”, “on”, “under”, “laterally”, “front”, “horizontal”, “vertical”, etc., as used herein, relate to the usual vehicle-fixed Cartesian coordinate system K containing mutually perpendicular longitudinal, transverse and height axes X, Y, Z of the vehicle 1.

The passenger compartment 5 of the vehicle 1 contains a vehicle seat (not depicted separately) having a headrest 6 for a vehicle occupant, for example the driver, who in this example is the user of the holo display 2 and is indicated in FIG. 1 only by their eyes A. The holo display 2 comprises a display light source 7 and a two-dimensional micromirror array 8 arranged opposite thereto in the visual field of the user, for example in the region of an instrument panel not depicted in detail.

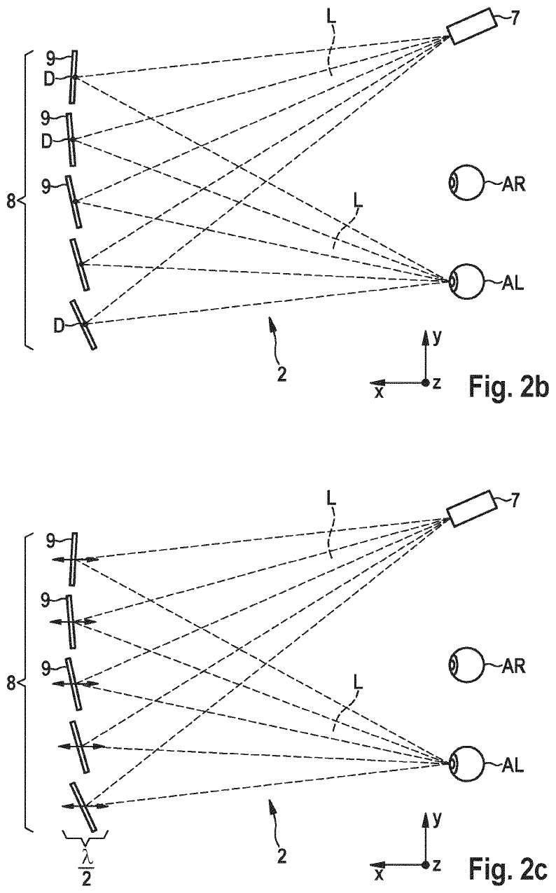

The two-dimensional micromirror array 8 comprises a plurality of micromirrors 9—five are shown purely symbolically—which are electrically controllable independently of one another and which are shown separately in FIGS. 2a-2c in highly enlarged fashion for reasons of presentation. Each micromirror 9 forms a display pixel by virtue of being translationally displaceable in a direction transverse to its mirror surface (cf. FIG. 2c) in order to impress on the display light L reflected thereon a phase shift serving for holographic reconstruction of a desired display image. As indicated by a rotary arrow in FIG. 2a, each micromirror 9 is moreover rotatable at least about a first axis of rotation D in order to reflect the display light L created by the display light source 7 to a respective eye AL (left eye) and AR (right eye) of the user in alternation.

In this example, the display light source 7 is embodied as a laser light source for creating at least partly coherent display light L at a predetermined wavelength A. In order to keep the required deflection by the micromirrors 9 as small as possible, it is advantageous to position the display light source 7 in the vicinity of the eyes A of the user but outside of a user display viewing angle which fills out a spatial region between their eyes A and the micromirror array 8. As shown in FIG. 1, the display light source 7 can for example be assembled/integrated in or on the roof liner 4 or alternatively in or on the headrest 6, so as not to restrict the forward view of the user on the micromirror array 8 and through the windshield 3, and so as not to restrict their freedom of movement.

In this example, the holo display 2 also includes an eye-tracking device 10 that is embodied to ascertain a current position of each eye AL and AR of the user. For example, it may comprise one or more cameras to this end, these cameras being able to be integrated or assembled in or on the micromirror array 8 or to the side thereof or at any other suitable position in the vehicle 1. In this case, each micromirror 9 is controllable for rotation at least about its first axis of rotation D such that the display light L created by the display light source 7 is reflected by the micromirror array 8 to the respective currently ascertained position of the relevant eye AL/AR of the user. An eye-tracking device 10 that is usable to this end can be provided as a constituent part of the holo display 2, or might be provided in any case onboard the vehicle 1, for example as a constituent part of a driver-monitoring system.

Below, an exemplary embodiment of an operating method for a holo display 2 according to the aspects of the invention described above and in the claims is described with reference to FIGS. 1, 2a-2c and FIG. 3. For example, the method can be carried out automatically by a suitable control unit 11 (see FIG. 1). FIGS. 2a to 2c each show the holo display 2 in a plan view in which the plane of the drawing using the example of the vehicle 1 from FIG. 1 is located parallel to a plane spanned by said vehicle's longitudinal axis X and said vehicle's transverse axis Y, as indicated in FIG. 2a.

During the operation of the holo display 2, at least partly coherent display light L is created by the display light source 7. The micromirrors 9 of the micromirror array 8 are controlled to perform, at least about their first axis of rotation D, such a rotation that the display light L created by the display light source 7 is reflected by the micromirror array 8 to a respective eye AL and AR of the user in alternation. In this case, FIG. 2a shows an operating position of the micromirror array 8 in which the display light L is reflected to the right eye AR of the user. FIG. 2b shows a further operating position obtained by rotating the micromirrors 9 through their first axis of rotation D, in the case of which the display light L is reflected to the left eye AL of the user. As mentioned above, the micromirrors 9 might each be additionally rotatable about a further axis of rotation, crossed with their axis of rotation D, in order to extend the adjustment to current eye positions by further degrees of freedom of movement.

As indicated by double-headed arrows in FIG. 2c, the individual micromirrors 9 (i.e. pixels) can in the process be moved transverse to the display plane, in each case by half a predetermined wavelength λ/2 of the display light L (in each case measured in the light propagation direction). In this way, it is possible to generate a phase offset of no more than 2π between the individual pixels and hence create a holographic image by way of interference of the individual pixels. As explained below, the translational displacement of the micromirrors 9 shown in FIG. 2c can optionally also be used, in addition, for a fine adjustment of the deflection direction of the micromirrors 9, for example for the calibration as specified above and in the claims, and for many further purposes.

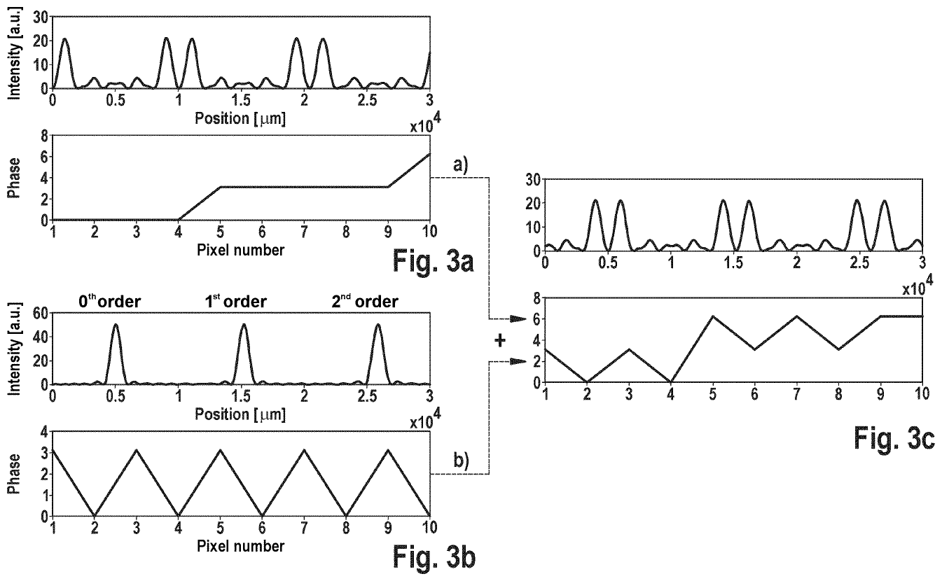

Thus FIGS. 3a to 3c each show a phase diagram serving to explain a specific configuration of the operating method of the holo display 2 with a superposition (FIG. 3c) of two phase patterns, of which the first (FIG. 3a) serves for holographic image creation and the second (FIG. 3b) for supplementary fine adjustment of the steering of light in addition to a rotation of individual micromirrors 9. This steering of light by a transverse displacement is possible since the phases for various light manipulations can be added (superposition principle). Thus, a certain phase pattern for the image creation (FIG. 3a) can be added to a further phase pattern for an overall deflection (FIG. 3b) of the display light beam L, and the superposition of these two phase patterns (FIG. 3c) creates a display image of the holo display which is appropriately displaced in angular space.

This basic functionality is illustrated in FIGS. 3a-3b by way of a simple 2-D simulation. A pixel array made purely by way of example of 10 pixels transmits spherical waves which amplify or cancel one another in space, depending on local phase differences between the individual spherical waves. Appropriate diffraction patterns arise in the far field. These diffraction patterns depend on the phase difference between the individual pixels, which is controllable by the transverse displacement thereof. Thus, in this example, the upper phase pattern (FIG. 3a) is used to create the desired image information, and the lower phase pattern (FIG. 3b) is used for an angular displacement of the reflected display light L.

As a result of the majority of light steering being implemented by way of the mirror rotation in this example (as illustrated in FIGS. 2a-2b), only relatively small deflection angles need to be realized by way of the holographic function illustrated in FIGS. 3a-3c. As a consequence, pixel dimensions of for example approx. 50 μm would be sufficient in the case of a purely exemplary observation distance of approx. 1 m. Thus, it is possible to create an image impression for the user in which both the convergence angle of the eyes and the focus information are self-consistent. To this end and purely by way of example, approx. 4000×2000 pixels (micromirrors 9) are required for a display (i.e. micromirror array 8) with a size of approximately 200×100 mm.

By contrast, pixel dimensions of the order of approximately 2.5 μm would be required if the intention were to create all of the light steering by way of the holographic function. A holo display with typical dimensions of 200×100 mm would require the number of pixels to total approximately 3.2 Gpixel as a result, which is thus far beyond all current manufacturing limits and all manufacturing limits achievable in the medium term.

The disadvantage mentioned at the outset of a very small observation angle for conventional holographic direct view displays is thus rectified in the structure presented here by way of the additional function of light deflection by way of the rotatable micromirrors 9 in combination with the eye-tracking signal from a suitable eye-tracking device 10. In other words, the micromirror array 8 is used not only for the image creation but also in order to deflect the display light L from the display light source 7 in such a way that it is incident on the eyes AL and, respectively, AR of the observer even if the display light source 7 is not positioned directly in front of the pupil of the respective eye AL/AR.

Using the construction concepts presented herein for a holo display 2, use thereof in vehicles is also realizable and, in the process, opens up new dimensions in view of the energy efficiency and display possibilities.

### LIST OF REFERENCE SIGNS

1 Vehicle
2 Holographic direct view display (holo display for short)
3 Windshield
4 Roof liner
5 Passenger compartment
6 Headrest
7 Display light source
8 Micromirror array
9 Micromirror
10 Eye-tracking device
11 Control unit
L Display light (beam)
D First axis of rotation of a micromirror
K Vehicle-fixed coordinate system
X, Y, Z longitudinal, transverse and height axis of the vehicle
A Eyes of the user
AL, AR Left and, respectively, right eye

1.-11. (canceled)

12. A holographic direct view display for a vehicle, the holographic direct view display comprising:
a display light source configured to create at least partly coherent display light; and
a two-dimensional micromirror array arranged opposite the display light source in a visual field of a user; wherein:
each micromirror is configured as an electrically actuatable display pixel that is translationally displaceable in a direction transverse to its mirror surface in order to impress a phase shift for holographic reconstruction of a desired display image on the display light reflected thereon and additionally rotatable at least about its first axis of rotation in order to reflect the display light created by the display light source to a respective eye of the user in alternation; and
the display light source is arranged outside of a user display viewing angle that fills out a spatial region between a predetermined eyebox for the user's eyes and the micromirror array.

13. The holographic direct view display according to claim 12, wherein:
any desired phase offset of between 0 and 2π is creatable between individual pixels by way of translational displacement.

14. The holographic direct view display according to claim 13, wherein:
each individual micromirror is translationally displaceable within a displacement interval which, in orthogonal projection on an associated light propagation direction of the display light reflected thereon, substantially corresponds to half a predetermined wavelength of the at least partly coherent display light.

15. The holographic direct view display according to claim 12, further comprising:
an eye-tracking device configured to ascertain a current position of each eye of the user;
wherein each micromirror is controllable for rotation at least about its first axis of rotation, such that the display light created by the display light source is reflected by the micromirror array to the respective current position of a relevant eye of the user.

16. The holographic direct view display according to claim 12, wherein:
each micromirror is configured to optically image the display light source into the respective eye of the user; and
each micromirror is configured as a concave mirror.

17. The holographic direct view display according to claim 12, wherein:
each micromirror is configured to optically image the display light source into the respective eye of the user; and
each micromirror is configured as a Fresnel mirror with an optical function of a concave mirror.

18. The holographic direct view display according to claim 12, wherein:
the rotatability of each micromirror of the micromirror array at least about its first axis of rotation comprises a rotatability about the first axis of rotation and, crossed with the first axis of rotation, a second axis of rotation of the respective micromirror.

19. The holographic direct view display according to claim 12, further comprising a calibration device comprising:
an infrared light source arranged next to or integrated in the display light source such that the infrared light source emits an infrared light beam substantially of a same shape and in a same direction as the display light created by the display light source; and
a calibration computing unit configured to obtain infrared recordings of a spatial region with the predetermined eyebox for the user's eyes, detect therein an image of the infrared light beam on a face of the user and determine deviations from a predetermined imaging quality and control the micromirrors to rotate at least about their first axis of rotation and/or perform a translational displacement, such that the deviations are reduced.

20. The holographic direct view display according to claim 12, further comprising a calibration device comprising:
an infrared light source arranged next to or integrated in the display light source such that the infrared light source emits an infrared light beam substantially of a same shape and in a same direction as the display light created by the display light source; and
a calibration computing unit configured to obtain infrared recordings of a spatial region with the predetermined eyebox for the user's eyes, detect therein an image of the infrared light beam on a face of the user and determine deviations from a predetermined imaging quality and control the micromirrors to rotate at least about their first axis of rotation and/or perform a translational displacement, such that the deviations are eliminated.

21. A method for operating the holographic direct view display according to claim 12, the method comprising:
creating at least partly coherent display light by the display light source; and
controlling the micromirrors of the micromirror array to perform such a rotation at least about their first axis of rotation that the display light created by the display light source is reflected to a respective eye of the user in alternation by the micromirror array; and
controlling each micromirror to perform such a translational displacement in a direction transverse to its mirror surface that a phase shift required for holographic reconstruction of a respective display image to be displayed is impressed on display light reflected from the micromirror.

22. The method according to claim 21, wherein:
in addition to the rotation of each micromirror, its translational displacement in the transverse direction is used to reflect the display light created by the display light source from the micromirror array to the respective eye of the user, by virtue of an additional phase shift contributing to the required light deflection to the respective eye of the user being impressed on the display light by the micromirror array, in addition to the phase shift required for the holographic reconstruction of the respective display image.

23. The method according to claim 21, wherein:
there is a calibration of the reflection of the display light, created by the display light source, to the respective eye of the user brought about by the micromirror array, by virtue of:
an infrared light beam substantially of a same shape and in a same direction as the display light being created;
infrared recordings of a spatial region with the predetermined eyebox for the user's eyes being provided;
an image of the infrared light beam on a face of the user being detected within the infrared recordings and being checked for deviations from a predetermined imaging quality; and
the micromirrors being controlled to rotate at least about their first axis of rotation (D) and/or to perform such a translational displacement in the transverse direction that the determined deviations are reduced.

24. The method according to claim 21, wherein:
there is a calibration of the reflection of the display light, created by the display light source, to the respective eye of the user brought about by the micromirror array, by virtue of:
an infrared light beam substantially of a same shape and in a same direction as the display light being created;
infrared recordings of a spatial region with the predetermined eyebox for the user's eyes being provided;
an image of the infrared light beam on a face of the user being detected within the infrared recordings and being checked for deviations from a predetermined imaging quality; and
the micromirrors being controlled to rotate at least about their first axis of rotation (D) and/or to perform such a translational displacement in the transverse direction that the determined deviations are eliminated.

25. A control unit configured to automatically perform the method according to claim 21.

26. A motor vehicle comprising:
a passenger compartment upwardly delimited by a roof liner at least in part;
a vehicle seat arranged in the passenger compartment and having a headrest; and
the holographic direct view display according to claim 12, configured for use by a user on the vehicle seat;
wherein the display light source is arranged outside of a user display viewing angle that fills out the spatial region between the predetermined eyebox for the user's eyes in the passenger compartment and the micromirror array.

27. A motor vehicle comprising:
a passenger compartment upwardly delimited by a roof liner at least in part;
a vehicle seat arranged in the passenger compartment and having a headrest; and
the holographic direct view display according to claim 12, configured for use by a user on the vehicle seat;
wherein the display light source is arranged outside of a user display viewing angle that fills out the spatial region between the predetermined eyebox for the user's eyes in the passenger compartment and the micromirror array on or in the roof liner or at, in or on the headrest of the vehicle seat.
